(19) United States
(12) Patent Application Publication
(10) Pub. No.: US 2024/0310001 A1
(43) Pub. Date: Sep. 19, 2024

(54) MODULAR PRESSURE VESSEL MOUNTING APPARATUS

(71) Applicant: Steelhead Composites, Inc., Golden, CO (US)

(72) Inventors: Andrew Coors, Littleton, CO (US); John Cronin, Lakewood, CO (US); Alexis Dubois, Nederland, CO (US); Christopher Schumacher, Thornton, CO (US); Camilla Voll, Golden, CO (US); Ryan Lee Kabbes, Waynesville, OH (US); Shohei Shibata, Oakwood, OH (US); Jude Hueber, Loveland, OH (US)

(73) Assignee: Steelhead Composites, Inc., Golden, CO (US)

(21) Appl. No.: 18/123,237

(22) Filed: Mar. 17, 2023

(51) Int. Cl. F17C 13/08; F17C 1/02

(52) U.S. Cl. CPC F17C 13/08; F17C 1/02; F17C 2201/0109; F17C 2201/032; F17C 2205/0107; F17C 2205/018; F17C 2221/012

(57) ABSTRACT

The present invention provides a modular pressure vessel mounting apparatus and methods for using the same in transporting or storing pressure vessels. In particular, the module pressure vessel mounting apparatus comprises:
a plurality of top sleeves (200A);
a plurality of bottom sleeves (200B);
a top-plate (300A) configured to fit said plurality of said top sleeves (200A);
a bottom-plate (300B) configured to fit said plurality of said bottom sleeves (200B); and
a restraining device (400) configured to hold each of the pressure gas vessels between each of said top sleeves (200A) and each of said bottom sleeves (200B).
   Typically, a plurality of pressure vessels are placed between the top-plate (300A) and the bottom-plate (300B) by placing a top sleeve (200A) and a bottom sleeve (200B) between the neck of the pressure vessel and the top-plate (300A) and the bottom of the pressure vessel and the bottom-plate (300B), respectively. The pressure vessels are then held in place using the restraining device (400), which prevents movement of pressure vessels within the module pressure vessel mounting apparatus (10).

### FIELD OF THE INVENTION

The present invention relates to a modular pressure vessel mounting apparatus and methods for using the same in transporting or storing pressure vessels.

### BACKGROUND OF THE INVENTION

Hydrogen gas is a useful alternative to fossil fuel based energy source. With advances in understanding of fossil fuel's impact on global weather and environment, demand for using alternative fuel sources has increased tremendously in the last few years. One of the key developments in alternative fuel sources is development of hydrogen gas based vehicles.

In order to be useful as an energy source, in particular for vehicles, a vast network of hydrogen refilling stations are needed. This refilling station network in turn requires transporting hydrogen gas tanks safely to refilling stations. Because hydrogen is highly flammable, care must be exercised in transporting this gas. In particular, to prevent dangerous conditions in transporting hydrogen gas tanks, one must meet various governmental regulations and international treaties, such as those prescribed in International Convention for Safe Containers (CSC) and Accord relatif au transport international des marchandises Dangereuses par Route (ADR), otherwise known as the International Carriage of Dangerous Goods by Road treaty.

Pressurized gases are also used in health industries (e.g., in hospitals and diagnostic centers) as well as in research, construction, semiconductor fabrication, and other industries. In fact, use of pressurized gases is ubiquitous in practically all industries in modern society. In many instances, pressurized gases are transported from its production facility to sites where they are stored and used.

Typically, multiple element gas container (MEGC) is used for the bulk storage and transportation of compressed gases. Unfortunately, conventional MEGC's do not provide rapid loading and unloading of pressure vessels (PVs) for transportation and storage. Moreover, most conventional MEGC's have fixed restraining system; thus, change in the size or dimension of PV requires a new MEGC system to be adapted. In addition, most conventional MEGC's are useful for transporting or storing a uniform size or dimension of PVs.

In order to accommodate various size of PVs, there is a need for an MEGC apparatus that can accommodate various dimensions of PVs. There is also a need for an MEGC apparatus that can be easily loaded and unloaded.

### SUMMARY OF THE INVENTION

Some aspects of the invention provide a multiple element gas container apparatus that allows for modular array of matrices of PVs for storage and transportation. In some embodiments, the apparatus of the invention allows ease of loading or dismounting PVs.

One particular aspect of the invention provides an apparatus (10) for mounting a plurality of pressure gas vessels (100) each of which comprises (i) a top-end (104A) formed with a first neck portion (104B) and (ii) a bottom-end (104B) formed with a bottom portion (108B). The apparatus (10) includes:
a plurality of top sleeves (200A) each of which is configured to fit at least a portion of each of the first neck portion (108A) of the pressure gas vessels (100), wherein each of said top sleeves (200A) comprises an orifice (204A) configured to allow a valve or boss of the pressure gas vessel (100) to protrude therethrough;
a plurality of bottom sleeves (200B) each of which is configured to fit at least a portion of each of the bottom portion (108B) of the pressure gas vessels (100);
a top-plate (300A) configured to fit said plurality of said top sleeves (200A), wherein said top-plate (300A) comprises a plurality of orifices (208A) configured to allow a valve or boss of the pressure gas vessel (100) to protrude therethrough or to allow access thereof;
a bottom-plate (300B) configured to fit said plurality of said bottom sleeves (200B); and
a plurality of pressure gas vessel restraining devices (400) configured to hold each of the pressure gas vessels (100) between each of said top sleeves (200A) and each of said bottom sleeves (200B).

High pressure vessels can easily be mounted and dismounted using the restraining devices (400). Moreover, individual set of apparatus (10) can be combined to provide a modular array of matrices of PVs for storage and transportation.

Another aspect of the invention provides a method for storing or transporting one or more of pressure gas vessels (100). The pressure vessel (100) comprises (i) a top-end (104A) formed with a first neck portion (108A) and (ii) a bottom-end (104B) formed with a bottom portion (108B). The method of storing or transporting pressure gas vessels comprises:
placing the bottom portion (108B) of each of one or more pressure gas vessels (100) on a bottom sleeve (200B) and the first neck portion (108A) on a top sleeve (200A) of a modular pressure gas mounting apparatus (10) disclosed herein, wherein said bottom sleeve (200B) is on an interior surface of a bottom-plate (300B) and said top sleeve (200A) is on an interior surface of a top-plate (300A);
placing a pressure vessel restraining device (400) to hold each of the pressure gas vessels (100) between each of said top-plate (300A) and each of said bottom-plate (300B); and
storing or transporting one or more pressure gas vessels (100).

### BRIEF DESCRIPTION OF THE DRAWINGS

FIG. 1 is a perspective view of one particular embodiment of two 1×5 modular pressure vessel mounting apparatuses of the invention along with a top frame mount that is used to immobilize or link both of the modular pressure vessel mounting apparatuses.

FIG. 2 is a perspective view of one particular individual modular pressure vessel mounting apparatus of the invention.

FIG. 3 is a close-up view of one particular embodiments of a bottom-plate (300B) for the modular pressure vessel mounting apparatus of the invention.

FIG. 4 shows a side-by-side perspective view of two top-plates (300A) of 1×5 modular pressure vessel mounting apparatuses of the invention.

FIG. 5 shows a perspective view of a rail system for storing modular pressure vessel mounting apparatus of the invention.

FIG. 6 is a close-up view of an intersection between x-axis rail and y-axis rail of the rail system indicated by a dashed circle in FIG. 5.

FIG. 7 is another embodiment of modular pressure vessel mounting apparatus having wheels on the bottom plate.

### DETAILED DESCRIPTION OF THE INVENTION

The present invention will be described with regard to the accompanying drawings, which assist in illustrating various features of the invention. In this regard, the present invention generally relates to a modular pressure vessel mounting apparatus and methods for using the same, for example, for storage and transportation. In particular, the invention relates to a modular pressure vessel mounting apparatus that can be used to provide a different array of pressure vessels for storage and transportation. For the sake of clarity and brevity, the present invention will now be described in reference to modular pressure vessel mounting apparatus in connection with hydrogen gas. However, it should be appreciated that the modular pressure vessel mounting apparatus of the invention is not limited to merely storing or transporting hydrogen gas. In fact, methods and apparatuses of the invention can be used generally for storing and transporting any pressurized vessels such as those containing compressed natural gas, helium, argon, nitrogen, oxygen, chlorine, or any other gases that are stored under a pressure vessel. Discussion of using the modular pressure vessel mounting apparatus of the invention is provided solely for the purpose of illustrating the practice of the invention and do not constitute limitations on the scope thereof.

Modular pressure vessel mounting apparatuses of the invention have many advantages and benefits compared to conventional pressure vessel mounting apparatuses. For example, pressure vessels can be easily placed or removed within the modular pressure vessel mounting apparatuses of the invention. This ease of mounting and unmounting of pressure vessels allows one to readily inspect or maintain pressure vessels. Furthermore, by having more than one pressure vessel attached to a single unit of modular pressure vessel mounting apparatus (10) of the invention, the apparatus (10) of the invention provides more rigid and secure means for storing or transporting pressure vessels. Moreover, linking or connecting each of the modular pressure vessel mounting apparatus (10) of the invention to one another further increases rigidity and security in storing or transporting pressure vessels. In general, the modular pressure vessel mounting apparatus (10) of the invention comprises a top plate and a bottom plate, each of which can is compartmentalized to securely hold individual pressure vessels and a secure means for rigidly holding the top plate and the bottom plate together to prevent movement of pressure vessels within the modular pressure vessel mounting apparatus. The strength (e.g., mechanical, tensile, etc.) of the top plate and the bottom plate along with the securing means is sufficiently high enough to meet all governmental regulations.

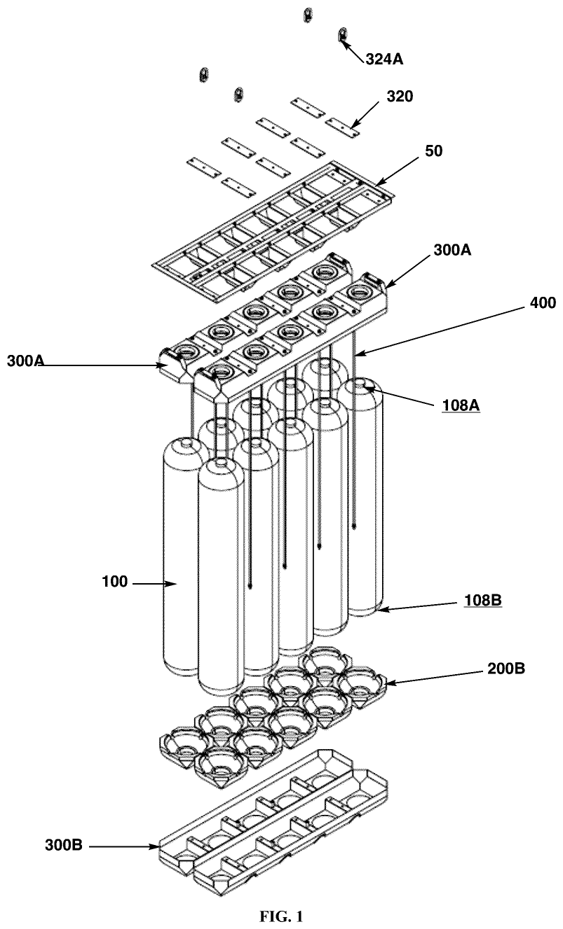

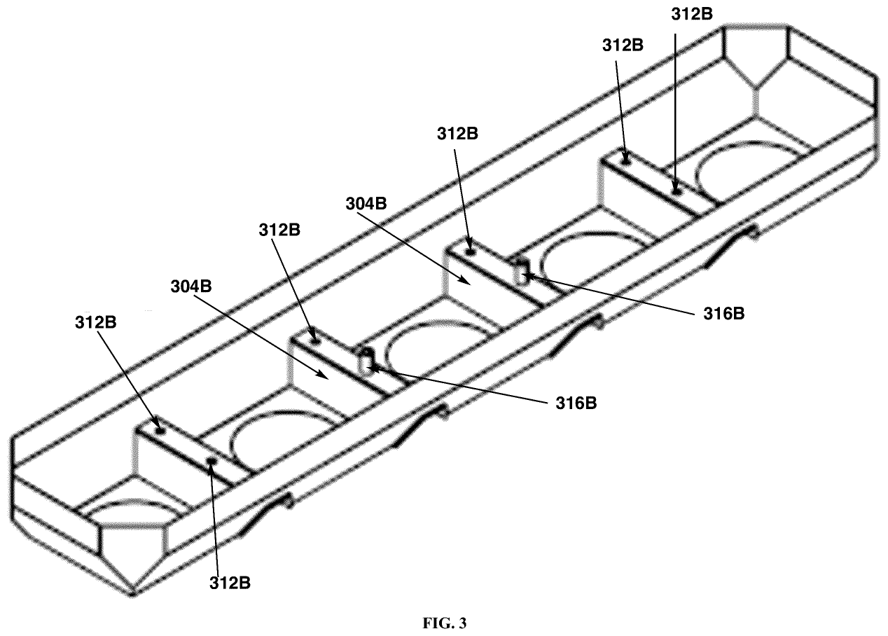

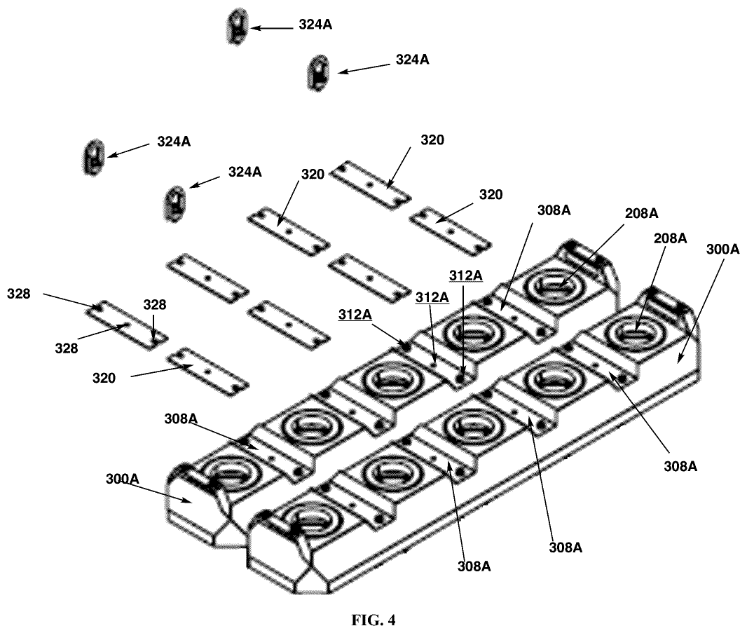

Some of the particular embodiments of the invention are generally illustrated in FIGS. 1-7, which are provided for the purpose of illustrating the practice of the present invention and which do not constitute limitations on the scope thereof.

Referring to FIGS. 1-4, modular array of matrices of PVs for storage and transportation include a modular apparatus. Illustrated in FIGS. 1-4 are 1×5 single modular pressure vessel mounting apparatus. However, a single modular apparatus of the invention can be of any configuration. For example, it can be, 1×1, 1×2, 1×3 . . . , 2×2, 2×3, 2×4 . . . , 3×3, 3×4, 3×5 . . . , etc. For convenience, and ease of adaptability, typical configuration of modular pressure vessel mounting apparatus of the invention has 1 row with 2 to 10, often 2 to 8, typically 2 to 5 columns. It should be appreciated, however, the scope of the invention is not limited to such a configuration. FIGS. 1-4 illustrate a modular pressure vessel mounting apparatus of the invention having 1×5 configuration.

As illustrated in FIGS. 1-4, the modular pressure vessel mounting apparatus (10) of the invention comprises:
a plurality of top sleeves (200A) each of which is configured to fit at least a portion of each of the first neck portion (108A) of the pressure gas vessels (100), wherein each of said top sleeves (200A) comprises an orifice (204A) configured to allow a valve or boss of the pressure gas vessel (100) to protrude therethrough;
a plurality of bottom sleeves (200B) each of which is configured to fit at least a portion of each of the bottom portion (108B) of the pressure gas vessels (100);
a top-plate (300A) configured to fit said plurality of said top sleeves (200A), wherein said top-plate (300A) comprises a plurality of orifices (208A) configured to allow a valve or boss of the pressure gas vessel (100) to protrude therethrough or to allow access thereof;
a bottom-plate (300B) configured to fit said plurality of said bottom sleeves (200B); and
a plurality of pressure gas vessel restraining devices (400) configured to hold each of the pressure gas vessels (100) between each of said top sleeves (200A) and each of said bottom sleeves (200B).

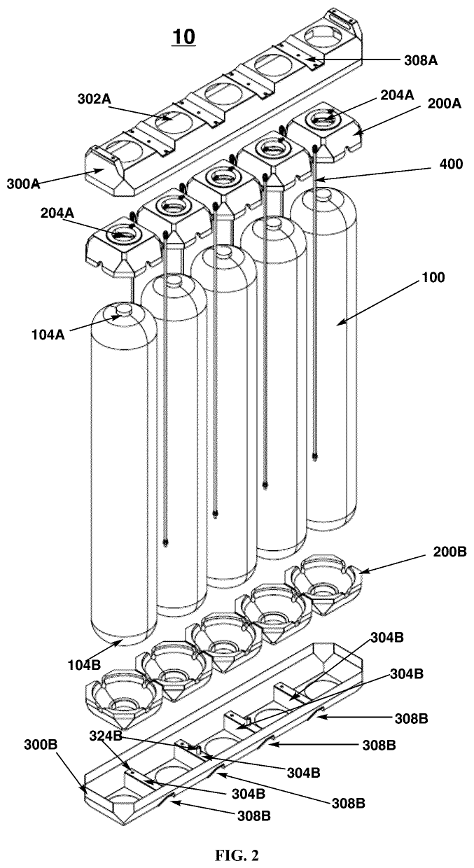

As can be seen in FIG. 2, the number of top sleeves (200A) and bottom sleeves (200B) used in any given modular pressure vessel mounting apparatus depends on the configuration of each modular pressure vessel mounting apparatus and by the number of pressure vessel (100) placed within the modular pressure vessel mounting apparatus. It should be appreciated, however, that not all of the position of modular pressure vessel mounting apparatus need to be used for any given modular pressure vessel mounting apparatus. Thus, for example, even though the modular pressure vessel mounting apparatus illustrated in FIGS. 1-4 is an array of 1×5, one can place only one, two, three, or four pressure vessels within the modular pressure vessel mounting apparatus.

Each of the top and bottom sleeves can be made from any material that can provide a sufficient mechanical strength for support and maintain structural integrity of pressure vessels. Such a material can include plastic, foam, rubber, or any other material that can provide support for structural integrity of pressure vessels placed within the modular pressure vessel mounting apparatus. The top and bottom sleeves prevent pressure vessels from movement within the modular pressure vessel mounting apparatus. In addition, top and bottom sleeves may also provide cushioning or motion dampening effect during transportation of pressure vessels. While top and bottom sleeves can have a different design and/or configuration, typically they are fabricated using a same technique. Use of the same fabrication method reduces the cost by, for example, using a single mold or extrusion-and-shaping process to produce both top and bottom sleeves.

In a typical operation, the bottom sleeves (200B) are placed within the bottom plate (300B). As can be seen in FIG. 2, in some embodiments, the bottom plate (300B) is compartmentalized to accept each pressure vessel in a separate bottom sleeve (200B). Such a compartmentalization can be achieved by any methods known to one of ordinary skill. In one particular embodiment, compartmentalization is achieved by a protuberance (304B). Such a protuberance can be in the form of a rail or a bar that separates one bottom sleeve (200B) from another. Once the bottom sleeves (200B) are placed within the bottom plate (300B), pressure vessels (100) are placed on top of the bottom sleeves (200B). The top sleeves (200A) are then placed on top or the neck of pressure vessels (100). As can be seen in FIGS. 1-2 and 4, the top sleeves (200A) include an orifice or an opening (208A). This orifice (208A) is adapted to accommodate a boss or valve (if present), or a top-end (104A) of the neck portion (108A) of the pressure vessel. Thus, the top sleeves (200A) fit snuggly on top of the neck portion (108A) of the pressure vessels.

Once the top sleeves (200A) are placed on top of the neck portion (108A) of pressure vessels (100), a top plate (300A) is placed on top of the top sleeves (200A). The modular pressure vessel mounting apparatus (10) is then secured by a restraining device (400) that connects the top plate (300A) to the bottom plate (300B). The restraining device (400) can be any device that can securely connect the top plate (300A) to the bottom plate (300B). Exemplary restraining devices include, but are not limited to, threaded-rods, ropes, steel straps, solid rods, square tubes, brackets, and any other restraining devices known to one skilled in the art, and any combination thereof. Regardless of what device is used as the restraining device (400), it must be strong enough to securely connect the top plate (300A) to the bottom plate (300B) without failing should there be unexpected movement of or force exerted to pressure vessels (100) that are securely placed within the modular pressure vessel mounting apparatus (10).

In one particular embodiment, the restraining device is a threaded rod and a tightening nut (324A), as shown in FIGS. 1 and 2. When a threaded rod (400) and a tightening nut (324A) is used as a fastening or restraining device, the bottom plate (300B) includes a threaded rod receptacle (324B). In some embodiments, the threaded rod receptacle (324B) protrudes from the rail or the bar (304B) that is used to compartmentalize each pressure vessel (100). See FIG. 2. In some embodiments, the threaded rod receptacle (324B) is a merely a threaded orifice that is present on the bar (304B). While the threaded rod (400) need not be threaded, it is easier to adjust the height of the modular pressure vessel mounting apparatus by using a threaded rod (400) and the tightening or fastening nut (324A). The threaded rod (400) can be attached to the bottom plate (300B) simply by a hook and a loop means or it can also include a threaded rod (400) and threaded rod receptacle (324B). A close-up view of the bottom plate (300B) shows threaded rod receptacle that is a threaded orifice (312B) within the bar (304B) and the threaded rod receptacle that is threaded protrusion (316B) located on top of the bar (304B).

As can be seen in FIGS. 1-2, a plurality of restraining devices, in this embodiment threaded rods (400), are typically used in modular pressure vessel mounting apparatus (10) of the invention. In particular, each pressure vessel has its own set of restraining devices. In this manner, each pressure vessel can be restrained independent of the other pressure vessels.

Referring to FIGS. 1-2 and 4, in some embodiments the top plate (300A) includes a recessed channel (308A). While not shown, the bottom plate (300B) can also include a similar recessed channel. The recessed channel (308A) can be used to separated or compartmentalize each pressure vessels. Moreover, the recessed channel (308A) can be used to place a reinforcement device for restraining devices. For example, when threaded rods (400) are used as the restraining device, a metal plate (320) or other similar materials having a high mechanical strength can be placed within the recessed channel (308A) for mechanical strength reinforcement. Similarly, the bottom plate (300B) can also include a similar recessed channels and reinforcement plates (not shown). If recessed channels and reinforcement plates are used in the bottom plate (300B), a threaded rod receptacle (324B) can be replaced with simple orifice that allows insertion of threaded rod (400) through the orifice and be fastened with fastening nuts similar to those described for fastening the top plate (300A) to the threaded rod (400) using the recessed channel (308A) and reinforcement plates (320). The reinforcement or metal plate (320) includes orifice (328) that allows threaded rod (400) to be inserted therethrough. The threaded rod (400) is then fastened with fastening nut (324A), thereby immobilizing pressure vessels (100) within the modular pressure vessel mounting apparatus (10).

As shown in FIG. 2, the top sleeve (200A) and top plate (300A) include an orifice (204A) and (302A), respectively, that allows boss or valve or even a portion of pressure vessel's neck to protrude therethrough. Placing the top sleeve (200A) and top plate (300A) on the top polar region or top-end (104A) of the pressure vessel through the orifices (204A) and (302A) prevents potential damage to the boss or valve that is mounted onto the pressure vessel as well as preventing damage to the pressure vessel's neck.

One unit of modular pressure vessel mounting apparatus (10) can be operatively connect to another unit of modular pressure vessel mounting apparatus (10) using a connecting module (50) as illustrated in FIG. 1. While the connecting module (50) shown in FIG. 1 is designed to connect two units of modular pressure vessel mounting apparatuses, the connecting module (50) can be configured to connect any number of units of modular pressure vessel mounting apparatuses. In this manner, one can store or transport an array of pressure vessels simultaneously.

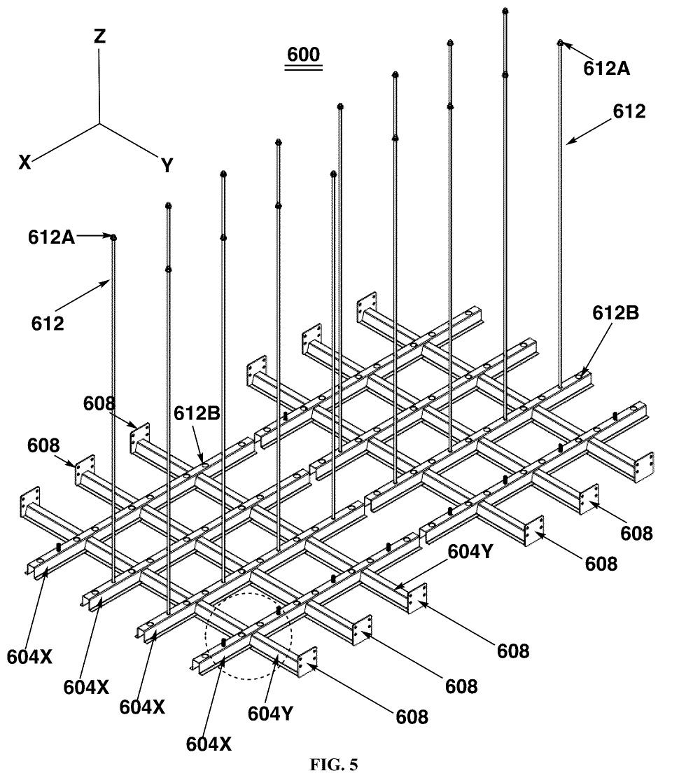

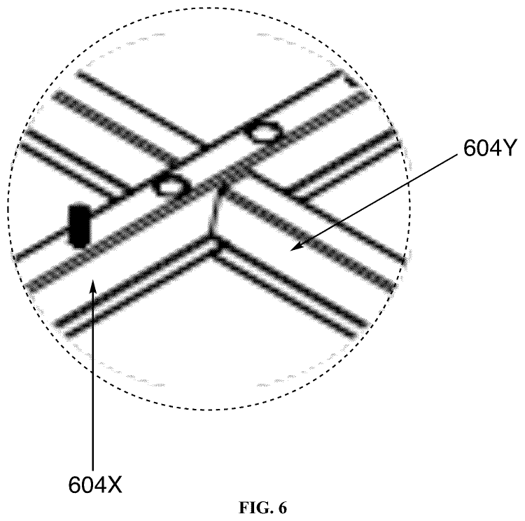

For ease of transporting or moving modular pressure vessel mounting apparatus (10), in some embodiments, a rail system (600) is provided. FIGS. 5 and 6. As shown in FIG. 5, the rail system allows placement or insertion of individual modular pressure vessel mounting apparatus (10) along the x-axis. As stated above, the bottom plate (300B) having recessed channels are arranged such that the recessed channels are placed on top of the x-axis rails or bars (604X). This allows insertion of a number of modular pressure vessel mounting apparatuses on to the rail system (600). The rail system (600) can also include mounting brackets (608) along its y-axis bars (604Y) that allows the rail system (600) to be attached to, for example, walls of a storage unit (not shown). As shown in FIG. 6, which is a close-up view of the intersection of x- and y-axis rails in FIG. 5, at the junction between the x-axis rail (604X) and y-axis bar (604Y), the height of x-axis rail (604X) is higher to allow unimpeded movement of the modular pressure vessel mounting apparatus (10) in x-axis direction. The rail system (600) can also include a secondary restraining system to prevent movement of modular pressure vessel mounting apparatus. In one particular embodiment, the secondary restraining system comprises a threaded rod (612) and the corresponding threaded rod insertion orifice (612B) on the x-axis rail (604X), and fastening bolt (612A).

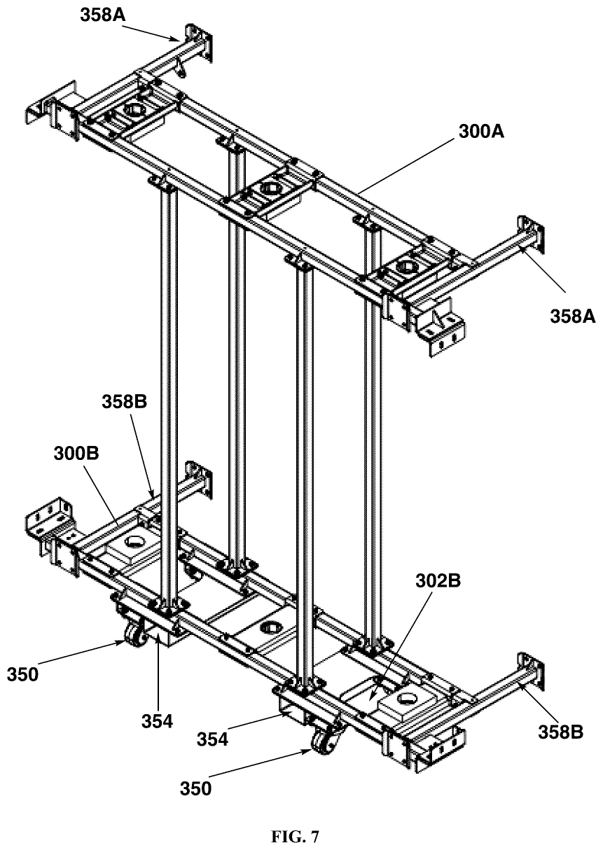

Another embodiment of top plate (300A) and bottom plate (300B) of the modular pressure vessel mounting apparatus (10) is shown in FIG. 7. In this embodiment, the bottom plate (300B) includes wheels. This embodiment of modular pressure vessel mounting apparatus (10) can also include linking or mounting brackets (358A and 358B) that allows attachment to a wall or interconnection of two or more the modular pressure vessel mounting apparatuses. As can be seen in FIG. 7, the bottom plate can also include an orifice (302B) which can be used as a receptacle for bottom sleeve (200B). In some embodiments, the bottom plate (300B) can also include slotted openings (354) which can be used, for example, in loading and unloading of the modular pressure vessel mounting apparatus (10) onto a transportation system. As an example, the slotted openings (354) allow insertion of forklift forks to aid in loading and unloading of the modular pressure vessel mounting apparatus (10) onto a truck or railroad.

Some of the advantages of modular pressure vessel mounting apparatus (10) of the invention include, but are not limited to, (i) use of dome injected molded hard foam/rubber/plastic sleeves on top and bottom of pressure vessels to provide full support for structural integrity; (ii) using a restraining device such as threaded rods to compress domes over pressure vessels to prevent movement; (iii) metal or thermoplastic injected molded top and bottom plates to provide bearing to attach threaded rods, piping, gas monitoring systems, control valves, etc.; (iv) bottom plate having a rail allowing for easy slip in and out of container or transportation system; (v) allowing modular array of matrices of pressure vessels; (vi) easy mounting and dismounting of pressure vessels, e.g., by disconnecting threaded rods; and (vii) ability to accommodate different height of pressure vessels easily by adjusting the threaded rod height. Furthermore, a modular design of the apparatus allows accommodation of different diameter and/or height of pressure vessels. In addition, modular arrays of apparatuses of the invention can be rolled or placed into a container or a transportation system and attached with the sturdy bottom rails.

In some embodiments, modular pressure vessel mounting apparatus (10) of the invention can be integrated with other safety systems, such as fire protection system and other safety features at the module and/or at individual tank level. Such incorporation of a safety feature makes a safe and reliable gas storage system that can be safely transported to supply energy.

Unlike most conventional pressure vessel transportation apparatuses that place the pressure vessels horizontally, modular pressure vessel mounting apparatus (10) of the invention is adapted for vertical configuration of pressure vessels offering quicker and better release of flammable gases, thereby providing increased safety compared to conventional pressure vessel transportation apparatuses.

The modular pressure vessel mounting apparatus (10) of the invention can be used for all types pressure vessels. Conventional pressures vessels are categorized within the following four types: (i) type 1, which are full metal cylinder made entirely from metal; (ii) type 2, which are metal cylinder that are reinforced by a belt-like hoop wrap with fiber-reinforced resin; (iii) type 3, which are fully wrapped thin metal liner vessels; and (iv) type 4, which are vessels having non-metal liner that are overwrapped with composite materials. Generally, type 4 pressure vessels are the lightest as these are typically made of a lightweight thermoplastic liner (providing gas tight barrier) that is the overwrapped with fibers. In type 4 pressure vessels, typically only the boss that is anchored to the liner is made of metal such as aluminum or stainless steel. While any type of pressure vessels can be used with the modular pressure vessel mounting apparatus (10) of the invention, type 4 pressure vessels are particularly useful. Because type 4 pressure vessels do not use a metal liner, they do not corrode, are resistant moisture, and can be used even in harsh salt environments.

While accompanying figures discussed herein show pressure vessels mounted vertically, one can easily configure the modular pressure vessel mounting apparatus of the invention to allow horizontal placement of pressure vessels. When pressure vessels are placed horizontally, the valve or connecting tubes are vertically placed such that when the pressure is accidentally released, the pressure vessels remain within the apparatus of the invention without having experiencing any horizontal propulsion. Typically, in horizontal placement of pressure vessels, the valve(s) or tubing(s) are placed vertically such that any release of pressure causes downward pressure of the vessel, thereby preventing any horizontal or upward propulsion experienced by the pressure vessels due to an accidental release of pressure.

Furthermore, while each pressure vessel (100) can have its own valve and regulator system, in some embodiments, the modular pressure vessel mounting apparatus (10) of the invention can serve as a single unit of pressure gas station. In this particular embodiment, only of the pressure vessel (100) is fitted with a regulator, while the other pressure vessels are interconnected via, for example, tube and/or valve. In this manner, the pressure vessel fitted with the regulator acts as a point of connection to a device utilizing the pressurized gas and the other pressure vessels in the modular pressure vessel mounting apparatus (10) of the invention acts as reserve gases.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

1. An apparatus (10) for mounting a plurality of pressure gas vessels (100) each of which comprises (i) a top-end (104A) formed with a first neck portion (104B) and (ii) a bottom-end (104B) formed with a bottom portion (108B), said apparatus (10) comprising:
a plurality of individual and separable top sleeves (200A) each of which is configured to fit at least a portion of each of the first neck portion (108A) of the pressure gas vessels (100), wherein each of said top sleeves (200A) comprises an orifice (204A) configured to allow a valve or boss of the pressure gas vessel (100) to protrude therethrough;
a plurality of individual and separable bottom sleeves (200B) each of which is configured to fit at least a portion of each of the bottom portion (108B) of the pressure gas vessels (100);
a top-plate (300A) configured to fit said plurality of individual and separable top sleeves (200A), wherein said top-plate (300A) comprises a plurality of orifices (208A) configured to allow the valve or boss of the pressure gas vessel (100) to protrude therethrough or to allow access thereof, and wherein an exterior surface of said top-plate (300A) comprises a plurality of top-plate recessed channels (308A);
a bottom-plate (300B) configured to fit said plurality of individual and separable bottom sleeves (200B), and wherein an exterior surface of said bottom-plate (300B) comprises a plurality of bottom-plate recessed channels (308B); and
a plurality of pressure gas vessel restraining devices (400) configured to hold each of the pressure gas vessels (100) between each of said individual and separable top sleeves (200A) and each of said individual and separable bottom sleeves (200B), wherein said restraining devices are placed within said plurality of top-plate recessed channels (308A) and said plurality of bottom-plate recessed channels (308B).

2. The apparatus of claim 1, wherein each of said restraining device (400) provides restraining force to each of the pressure gas vessels.

3. The apparatus of claim 1, wherein each of said restraining device (400) is operatively connected to said top-plate (300A) and said bottom-plate (300B).

4. The apparatus of claim 1, wherein each of said restraining devices (400) independently comprise a threaded rod, rope, steel strap, solid rod, square tube, bracket, or a combination thereof.

5. The apparatus of claim 4, wherein said restraining device (400) comprises a threaded rod and a tightening nut.

6. The apparatus of claim 1, wherein an interior surface of said bottom-plate (300B) comprises a plurality of protuberances (304B) thereby providing a separate compartment for each of said pressure gas vessels (100).

7. The apparatus of claim 6, wherein each of said protuberances (304B) comprises a mechanism for retaining said plurality of pressure gas vessel restraining devices (400).

8. The apparatus of claim 7, wherein said mechanism comprises a threaded orifice (312B).

9. The apparatus of claim 7, wherein said mechanism comprises a threaded protuberance (316B).

10-11. (canceled)

12. The apparatus of claim 1, wherein each of said top-plate recessed channels (308A) comprises a removably attached fastening support plate (320) that is adapted to provide additional mechanical strength for restraining devices (400) to hold each of the pressure gas vessels (100) between each of said top sleeves (200A) and each of said bottom sleeves (200B).

13. (canceled)

14. The apparatus of claim 1, wherein said pressure gas vessels (100) are placed horizontally within said apparatus.

15. A method for storing or transporting one or more of pressure gas vessels (100) each of which comprises (i) a top-end (104A) formed with a first neck portion (108A) and (ii) a bottom-end (104B) formed with a bottom portion (108B) using one or more pressure vessel mounting apparatus (10), wherein said pressure vessel mounting apparatus comprises:
a plurality of individual and separable top sleeves (200A) each of which is configured to fit at least a portion of each of the first neck portion (108A) of the pressure gas vessels (100), wherein each of said individual and separable top sleeves (200A) comprises an orifice (204A) configured to allow a valve or boss of the pressure gas vessel (100) to protrude therethrough;
a plurality of individual and separable bottom sleeves (200B) each of which is configured to fit at least a portion of each of the bottom portion (108B) of the pressure gas vessels (100);
a top-plate (300A) configured to fit said plurality of individual and separable top sleeves (200A), wherein said top-plate (300A) comprises a plurality of orifices (208A) configured to allow a valve or boss of the pressure gas vessel (100) to protrude therethrough or to allow access thereof, and wherein an exterior surface of said top-plate (300A) comprises a plurality of top-plate recessed channels (308A);
a bottom-plate (300B) configured to fit said plurality of individual and separable bottom sleeves (200B), and wherein an exterior surface of said bottom-plate (300B) comprises a plurality of bottom-plate recessed channels (308B); and
a plurality of pressure gas vessel restraining devices (400) configured to hold each of the pressure gas vessels (100) between each of said individual and separable top sleeves (200A) and each of said individual and separable bottom sleeves (200B), wherein said restraining devices are placed within said plurality of top-plate recessed channels (308A) and said plurality of bottom-plate recessed channels (308B),
said method comprising:
placing the bottom portion (108B) of each of one or more pressure gas vessels (100) individually and separately on said bottom sleeve (200B) and the first neck portion (108A) on said top sleeve (200A) of said pressure vessel mounting apparatus, wherein said bottom sleeve (200B) is on an interior surface of a bottom-plate (300B) and said top sleeve (200A) is on an interior surface of a top-plate (300A), and wherein an exterior surface of said top-plate (300A) comprises a plurality of top-plate recessed channels (308A) and an exterior surface of said bottom-plate (300B) comprises a plurality of bottom-plate recessed channels (308B);
placing a plurality of pressure gas vessel restraining devices (400) to hold each of the pressure gas vessels (100) between each of said top-plate (300A) and each of said bottom-plate (300B) by fastening each of said plurality of top-plate recessed channels (308A) to each of said plurality of bottom-plate recessed channels (308B) using said plurality of restraining devices (400); and
storing or transporting one or more pressure gas vessels (100).

16. The method of claim 15, wherein each of said plurality of top-plate recessed channels (308A) comprises one or more top-recessed channel orifices (312A).

17. The method of claim 15, wherein said step of placing the plurality of pressure gas vessel retaining devices (400) comprises placing a fastening support plate (320) in said top-plate recessed channel (308A) and placing a threaded rod (324) through a support plate orifice (328) of the fastening support plate (320) and through said top-recessed channel orifice (312A) and fastening the threaded rod (324) to a bottom-plate orifice (312B) that is present within each of said plurality of bottom-plate recessed channels (308B).

18. The method of claim 17, wherein said bottom-plate (300B) comprises a plurality of protuberances (304B) corresponding to each of said plurality of bottom-plate recessed channels (308B) to provide a separate compartment for each of said pressure gas vessels (100), and wherein said threaded orifice (312B) is present on top of said protuberance (304B).

19. A modular pressure vessel mounting apparatus comprising a plurality units of pressure vessel mounting apparatus, wherein each unit of said pressure vessel mounting apparatus comprises:
a top-plate (300A) configured to fit a plurality of individual and separable top sleeves (200A);
a bottom-plate (300B) configured to fit a plurality of individual and separable bottom sleeves (200B), and wherein an exterior surface of said bottom-plate (300B) comprises a plurality of bottom-plate recessed channels (308B);
a plurality of individual and separable top sleeves (200A) adapted to be placed between a neck portion of a pressure vessel and the top-plate (300A);
a plurality of individual and separable bottom sleeves (200B) adapted to be placed between a bottom portion of the pressure vessel and the bottom-plate (300B); and
a restraining device (400) configured to hold each of a pressure gas vessel between each of said individual and separable top sleeves (200A) and each of said individual and separable bottom sleeves (200B).

20. The modular pressure vessel mounting apparatus of claim 19, wherein each unit of said pressure vessel mounting apparatus (10) is attached to an adjacent unit of said pressure vessel mounting apparatus.

21. The method of claim 15, wherein a storage area or a transporting device for storing or transporting one or more of pressure gas vessels (100) comprises a rail-system (600) for guiding movement of the pressure vessel mounting apparatus (10), and wherein said step of storing or transporting one or more pressure gas vessels (100) comprises placing one or more said pressure vessel mounting apparatus (10), each of which comprising one or more pressure gas vessels (100) on to said rail-system (600), such that each of said plurality of bottom-plate recessed channels (308B) are placed on top of each of a plurality of x-axis rails or bars (604X) of said rail-system (600).
